(19) United States
(12) Patent Application Publication
(10) Pub. No.: US 2006/0123933 A1
(43) Pub. Date: Jun. 15, 2006

(54) Flow measuring method and device

(76) Inventor: Nils Arne Braaten, Trondheim (NO)

Correspondence Address: DENNISON, SCHULTZ, DOUGHERTY & MACDONALD, 1727 KING STREET, SUITE 105, ALEXANDRIA, VA, 22314, US

(21) Appl. No.: 10/524,773

(22) PCT Filed: Jul. 10, 2003
(86) PCT No.: PCT/NO03/00244

§ 371 Date: Feb. 16, 2005

(30) Foreign Application Priority Data
Aug. 27, 2002 (NO) 20024089

(51) Int. Cl. G01D 21/00

(52) U.S. Cl. 73/866.5

(57) ABSTRACT

Flow measuring method and device for measuring the velocity of a single-phase or multi-phase flow. The method includes calculating the flow velocity U only by measuring consecutive values of pressure p, temperature T and momentum D, and then calculating the change in pressure Δp, change in temperature ΔT and change in momentum ΔD. The device includes a probe with a housing having electronic components connected to different sensors in the probe. The probe has a long, hollow momentum tube, fastened by its first end to the housing and a hollow, cylindrical sensor tube, located inside the momentum tube fastened by its first end to the first end of the momentum tube. The sensor tube includes plate capacitors located on the outside of the second end, and is thereby able to measure the conductance between the momentum tube and the plate capacitors on the sensing tube. The probe has a pressure sensor and a temperature sensor.

The present invention relates to a method for measuring velocity in a single-phase or multi-phase flow, and a device for measuring different parameters in the flow, as stated in the introduction of claim 1 and 4.

### BACKGROUND OF THE INVENTION

Several measuring devices to measure different parameters in processes are known, the parameters being such as pressure, temperature, erosion, flow velocity and flow direction, momentum etc. Within the oil and gas industry it is especially important to monitor the conditions of the medium in different places in the installation; in process pipes, process tanks etc, thereby making initiatives possible if unforeseen or unwanted operation conditions should arise. A probe can be set into the process pipe via a nipple, then it is secured to the pipe by means of a flange on the pipe nipple.

An erosion measuring device is, for example, known from Norwegian patent publication 176292, and will not be further described herein. Moreover, there are several other measuring devices available, which measure pressure and temperature.

Further, different momentum measuring devices are known, for example from international patent application WO 95/16186 and U.S. Pat. No. 4,788,869. These momentum measuring devices are based on the movement of a long first pipe in relation to a second pipe placed inside the first pipe, where the movement is caused by a flow, which again causes a change in the distance between the first and the second pipe. The change in distance is measured as change in the conductance between the first and the second pipe so that using calibration data the actual momentum can be measured.

Further measuring devices are nowadays used for the measurement of flow density based on ultra sonic waves or gamma rays. Also measuring devices are used for the measurement of water fraction, where the share of liquid in the flow is measured. These measuring devices are expensive, complex and bulky.

U.S. Pat. No. 4,419,898 relates to a method and an apparatus to calculate the mass flow of a fluid based on the measurement of pressure, temperature and density of the fluid.

In a process installation there is a need for measuring several of these parameters at different locations. In this way there is a need for many different probes at different locations in order to achieve sufficient information regarding the condition of the installation. Both pipes with pipe nipples and the different probes are expensive, and maintenance is also demanding or labour and expensive. At the same time it is a problem that the different measurements are done at different locations in the process pipe. Consequently a time delay occurs between the measurement of, for example, momentum and density, which again cause inaccurate measuring results.

### OBJECT OF THE INVENTION

It is an object of the present invention to provide a measuring method for measuring flow velocity and for measuring the volume fraction of water, oil and gas, without firstly measuring the density of the flow. It is also an object of the invention to provide a probe capable of performing the measuring method.

The object of the invention is to provide one probe that is able to perform several measurements at the same location and at the same time in a process pipe.

At the same time it is an object to provide a total system that becomes less complex, with fewer pipe nipples and fewer probes. Further, it is an object of the invention that the replacement of the probes and maintenance on the system is made easier and that the costs of accomplishing this are reduced.

### THE INVENTION

The invention appears from the characterizing part of claim 1 and 4. Other embodiments of the invention are set from the independent claims.

According to claim 1 it achieves measurement of flow velocity by means of the following parameters: momentum, pressure and temperature. In this way the disadvantages of firstly performing the flow density measurement is avoided.

According to claim 4 a probe that is able to perform the method above is disclosed. According to claim 5 it is disclosed that the erosion of the flow is measured with the same probe. Consequently the total installation can comprise fewer probes and fewer pipe nipples, which will reduce the total costs. The probe also makes it possible to perform measurements at the same location and at the same time, which result in increased accuracy.

In addition this multi-functional probe can be combined with software-based models for the solution of Navier-Stokes flow equations, thereby quantifying the volume of each phase.

### EXAMPLE

In the following, embodiments of the present invention will be described with references to the enclosed drawings, where:

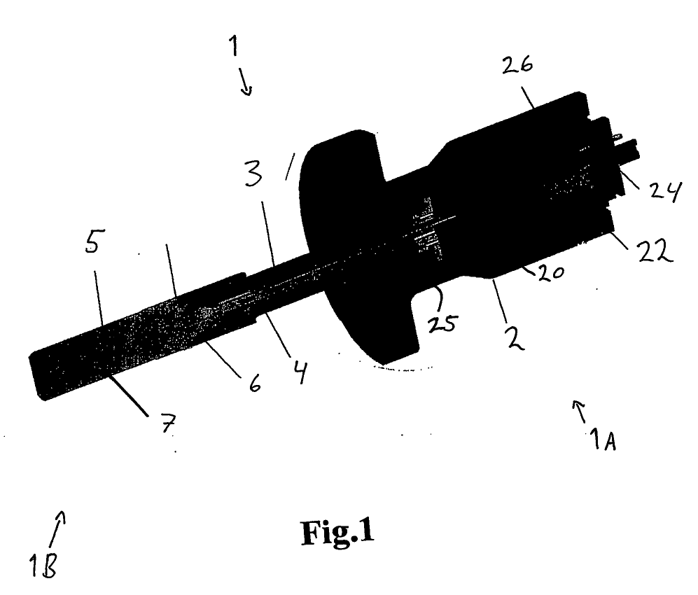

FIG. 1 shows a sectioned perspective view of a preferred embodiment according to the invention;

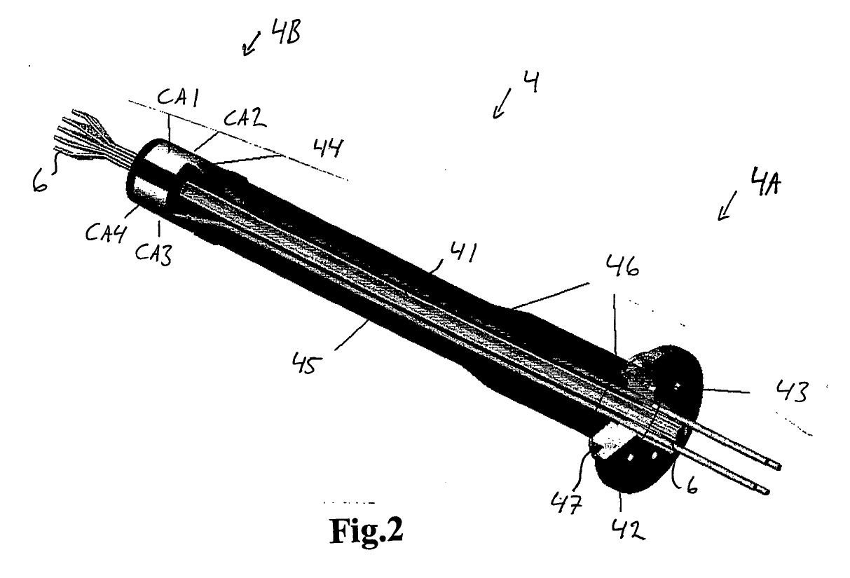

FIG. 2 shows a sectioned perspective view of the momentum tube of FIG. 1; and

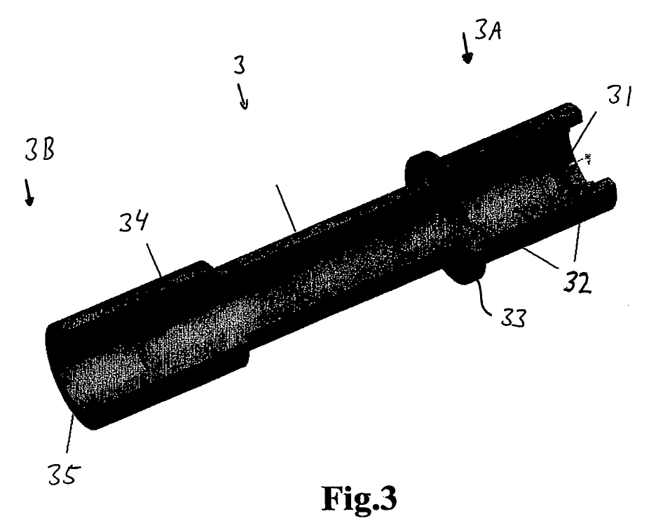

FIG. 3 shows a sectioned perspective view of the sensor tube of FIG. 1.

A probe 1 according to a preferred embodiment of the invention is shown in FIG. 1. The probe is comprised of a housing 2, a momentum tube 3, a sensor tube 4, an erosion sensor 5 and a pressure- and temperature sensing unit 7. The probe is meant to be inserted into a process pipe, a process tank etc via a pipe nipple, for measurement of different parameters of the media in the process pipe or the process tank.

The cross section of the housing 2 is substantially annular, and it comprises a circular cavity 20 along the length of the housing. Further, the housing 2 comprises a flange 21 for fastening the probe 1 to the pipe nipple, a cover 22 to protect the cavity 20, and a bushing 24. The housing also comprises an internal edge 25, where the sensor pipe 4 is secured to the housing 2.

The cover 22 is fastened to the housing 2 by means of a threaded connection 26, The bushing 24 is similarly fastened to the cover 22. In this way, the cover 22 and the bushing 24 are providing a second barrier between the process medium and the outside.

Electrical wires 6 are guided from the sensors in a second part 1B of the probe, through the momentum tube 3 and the sensor tube 4 to the cavity 20 of the housing 2, where the necessary electronic components of the probe are located. Further there are electrical wires leading from the electrical components out from a first part 1A of the probe, through the bushing 24 to a central monitoring unit or similar. The electric components will not be described here, since these may have several different embodiments depending on requirements regarding which parameters are to be measured, and the accuracy of the measurements etc. In this embodiment the electrical components comprise a power supply unit, an ATMEL ATMega 128 microprocessor with software, a capacitor' sensor amplifier, (for example QT9704B2 from Quantum Research Group Ltd.) among other components.

The momentum tube 3 is substantially cylindrical, and has a longitudinal cylindrical cavity (see FIG. 2). The momentum tube 3 is preferably made as one unit. Its first end 3A comprises an inwardly threaded part 31, inwardly conic parts 32 and an external collar 33. In its second end 3B the momentum tube 3 comprises an inwardly cylindrical surface 34 and an inwardly threaded part 35. The momentum tube is preferably made of an electrically conducting and corrosion resistant material.

The sensor tube is also substantially cylindrical, and has a longitudinal cylindrical cavity 41 for electric wires 6 (see FIG. 3). Further, in its first end 4A the sensor tube 4 comprises a flange 42 for fastening to the internal edge 25 in the housing 2 by means of adjusting screws 43, and an outwardly threaded part 47. In a second end 4B the sensor tube 4 comprises an outwardly cylindrical part 44 of an electric isolating material, where four plate capacitors CA1, CA2, CA3, CA4 are located outside the cylindrical part 44, the capacitors being connected to the electrical components in the housing 2. On the longitudinal, central part the sensor tube comprises an external rubber packer 45, which at the first end 4a has circular, externally conical parts 46.

The assembly of the housing 2, the momentum tube 3 and the sensor tube 4 will now be described. The first end 3A of the momentum tube 3 is firstly inserted into the cavity 20, such that the external collar 33 is supported against an area of the flange 21. From the opposite side of the housing 2 the second end 4B of the sensor tube 4 is inserted through the cavity 20 through the first end of the momentum tube 3, and the outwardly threaded part 7 of the sensor tube 4 is screwed onto the inwardly threaded part 31 of the momentum tube 3.

The momentum tube 3 may comprise a radially located latch pin to lock the momentum tube 3 and the sensor tube 4 in relation to each other, thereby preventing any rotation of the sensors in the other part 1B of the probe relative to the wanted direction.

In this position the exterior conical part 46 of the sensor tube is supported against the interior conical parts 32 of the momentum tube, and at the same time the cylindrical part 44 of the sensor tube, comprising the plate capacitors CA1, CA2, CA3, CA4, is located inside of and radially at a distance from the inner cylindrical surface 34 of the momentum tube.

The exterior flange 42 is then fastened to the inner edge 25 of the housing 2 by means of the adjustment screws 43. The area between the exterior collar 33 and the flange 21 is welded. The sensor is connected to the electrical components which is located in the cavity 20. The cover is put on, and finally the area between the housing 2 and the cover 22 is welded.

Dependant on the parameters to be measured, additional sensor units are placed on the other end 3B of the momentum tube. Preferably additional sensor units have outwardly directed threads adapted to the inwardly threaded part 35. When the sensor units are screwed in, the area between the momentum tube and the sensor tube is welded. Two different alternatives will be described in the following.

In a simple embodiment a pressure and temperature unit (not shown) are inserted into the momentum tube. The pressure and temperature unit comprises for example a circular or disk-shaped pressure and temperature sensor inserted into or welded into the substance of the unit. The pressure and temperature sensor can, for example, be a piezoelectric unit with its own separation membrane for pressure transfer.

In a preferred embodiment the probe 1 comprises an additional erosion sensor 5, known per se. The erosion sensor 5 comprises an outwardly threaded part adapted to the inwardly threaded part 35, where the electric wires 6 conduct signals to the electric components. The pressure and temperature unit 7 here, for example, is integrated as a part of the erosion sensor 5, as shown in FIG. 1.

The momentum measurement will in the following be described briefly, since it is basically known from the publications cited above. The momentum tube 3 forms the flexible part during the momentum measurement. When the flow generate an input to the probe, the second part 3B of the momentum tube 3 will be deflected a small distance, and the capacitance between the conductor plates CA1, CA2, CA3, CA4 on the sensing tube 4 and the inner cylindrical surface 34 of the momentum tube will be measured by the electronic components in the housing 2. The capacitance is then compared to measurements performed during calibration, and the momentum is calculated.

The fluid velocity can be calculated from the following equations as functions of momentum, temperature and pressure, that is, without having to firstly measure the density.

$$ρ = \frac{{R}_{mix} T}{p} \qquad ( 1 )$$

Here, Rₘᵢₓ is the universal gas constant, T is temperature and p is pressure.
Differentiating equation (1) results in:

$$Δ ρ = - \frac{{R}_{mix} T}{{p}^{2}} Δ p + \frac{{R}_{mix}}{p} Δ T \qquad ( 2 )$$

Here, Δρ is change in densitiy, ΔT is change in temperature, and Δp is change in pressure.

Two previous measurements are now used to derive the change in velocity ΔU from equation (2).

By using the principle of continuity the change in velocity ΔU can be expressed by the change in density Δρ, and vice versa:
ρU=(ρ+Δρ)(U+ΔU) (3)
Finally, the impulse equation is used, resulting in:

$$= Δ U , = - U \frac{Δ ρ}{ρ}$$

Here, D is an expression of the measured momentum, ΔD is change in measured momentum, while c_{D} is the momentum coefficient depending on the area of the probe, the shape of the probe etc.

The following expression is achieved by replacing ΔU in equation (3):

$$Δ D = - {U}^{2} Δρ + \frac{1}{2} {U}^{2} Δρ = - \frac{1}{2} {U}^{2} Δρ \qquad ( 5 )$$

We now find the velocity U from the change in momentum ΔD, where Δρ is a function of the measured values for ΔT, T, Δp and p in equation (2).
The accuracy in the method is very dependant on the quality of the measured pressure, temperature and momentum parameters. This type of analysis will provide the necessary quality and the required accuracy.

It is further possible to connect other known sensor units between the momentum tube 3 and the erosion sensor 5, or possibly between the momentum tube 3 and the pressure and temperature unit.

1. Flow measuring method for the measurement of velocity in a single-phase or multi-phase flow, such as a multi-phase flow in a process pipe or similar, characterized in measuring two consecutive values of pressure p, temperature T and momentum D, then to calculate the change in pressure Δp, change in temperature ΔT and change in momentum ΔD, where the method further comprises the steps of calculating the velocity U after the following formula:
ΔD=−½U²Δp (5)
where Δp is expressed as
$$Δ p = - \frac{{R}_{mix} T}{{p}^{2}} Δ p + \frac{{R}_{mix}}{p} Δ T \qquad ( 2 )$$
where Rₘᵢₓ is the universal gas constant.

2. Method according to claim 1, characterized in that the method further comprises the step of measuring the pressure p, the temperature T and the momentum D in the proximity of each other in the process pipe.

3. Method according to claim 1, characterized in that the method further comprises the step of measuring the pressure p, the temperature T and the momentum D at the same time.

4. A flow measuring device for measuring different parameters in a single-phase or multi-phase flow in a process pipe or process tank or similar, where a probe (1) comprises a housing (2) in a first end (1A) and sensors in a second end (lb), where the housing (2) comprises a flange (21) able to be fastened to a pipe nipple in the process pipe or the process tank, and where the housing (2) preferably comprises electronic components connected to the different sensors in the probe (1) to perform the measurements and then to calibrate and transfer the measured results to a central monitoring unit, where the probe (1) further comprises a long, hollow momentum tube (3) fastened by its first end (3A) to the housing (2), where the second end (3B) of the momentum tube (3) is inserted into the process pipe or process tank, and where the probe (1) further comprises a hollow cylindrical sensor tube (4) located inside the momentum tube (3) and fastened by a first end (4A) thereof to the first end (3A) of the momentum tube (3), where the sensor tube (4) comprises plate capacitors (CA1, CA2, CA3, CA4) located on the outside of the second end (4B), thereby being able to measure the conductance between the momentum tube (3) and the plate capacitors (CA1, CA2, CA3, CA4) on the sensing tube (4), characterized in that the probe comprises a pressure sensor, a temperature sensor and a momentum sensor.

5. Probe according to claim 4, characterized in that the pressure sensor and the temperature sensor are encapsulated in, or inserted in, a pressure and temperature unit located in the second end (3B) of the momentum tube (3).

6. Probe according to claim 4, characterized in that the probe in its second end further comprises an erosion sensor (5) known per se.

7. Probe according to claim 6, characterized in that the erosion sensor comprises a pressure and temperature unit (7).
